(19) United States
(12) Patent Application Publication
(10) Pub. No.: US 2016/0001538 A1
(43) Pub. Date: Jan. 7, 2016

(54) SYSTEM AND METHOD FOR STRUCTURAL REINFORCEMENT

(71) Applicant: Sto Corp., Atlanta, GA (US)

(72) Inventors: John Edgar, Freelton (CA); Meho Karalic, North Vancouver (CA)

(21) Appl. No.: 14/789,145

(22) Filed: Jul. 1, 2015

Related U.S. Application Data
(60) Provisional application No. 62/020,317, filed on Jul. 2, 2014.
(60) Provisional application No. 62/049,317, filed on Sep. 11, 2014.

(51) Int. Cl. B32B 37/14

(52) U.S. Cl. CPC B32B 37/14; B32B 2305/38; B32B 2305/72

(57) ABSTRACT

The present disclosure is directed to systems and methods for structural reinforcement against shear forces. The reinforcement systems comprise a fluid-applied coating applied to a surface of a substrate of a structure and a mesh applied to the fluid applied coating, adhered to the substrate by the fluid applied coating, and exhibiting an area density of at least about 200 g/m². The mesh can be disposed between the first and a second fluid-applied coating and can be oriented in various configurations to increase the resistance of the substrate to shear forces.

### RELATED APPLICATION

This application claims the benefit of priority to U.S. Provisional Patent Application No. 62/020,356, filed Jul. 2, 2014 and U.S. Provisional Patent Application No. 62/049,317, filed Sep. 11, 2014. The provisional patent applications identified above are hereby incorporated by reference in their entirety herein to provide continuity of disclosure.

### TECHNICAL FIELD

The present disclosure is directed generally to construction systems and methods, and more particularly to systems and methods for structural reinforcement.

### BACKGROUND

In the construction industry, one of the issues on which industry participants must focus is the ability of a structure to withstand shear and lateral forces, which can originate from both wind and geologic disturbance. Such forces can damage and destroy structures and be a danger to human health and safety. Current building systems have varying degrees of resistance to shear forces and many would benefit from systems and methods that could enhance their resistance to such forces.

Consequently, there is a need for systems and methods of structural reinforcement that address such forces.

### SUMMARY

The present disclosure encompasses systems and methods for structural reinforcement. The systems and methods of structural reinforcement of the present disclosure potentially can be used to enhance the resistance of a wall, building or other structure to shear and lateral forces.

In one embodiment, the present disclosure encompasses a system for structural reinforcement that can comprise a reinforcement layer disposed on a surface of a substrate of a structure, wherein the surface can comprise a base, a top aligned distal to the base, a height extending between the base and the top, and an area disposed between the base and the top. The reinforcement layer can extend along a majority of the height of the surface, and the reinforcement layer can comprise a first fluid-applied coating disposed on the surface, a mesh disposed on the first fluid-applied coating, wherein the mesh is adhered to the substrate by the first fluid-applied coating, and wherein the mesh exhibits an area density of at least about 200 g/m², and a second fluid-applied coating disposed on the mesh and at least a portion of the first fluid-applied coating. In one aspect, the reinforcement layer further can comprise a second mesh disposed on the second fluid-applied coating. In another aspect, the reinforcement layer further can comprise a third fluid-applied coating disposed on the second mesh and at least a portion of the second fluid-applied coating. In a further aspect, at least one of the first fluid-applied coating, the second fluid-applied coating and the third fluid-applied coating can comprise an elastomeric polymer. In still a further aspect, the elastomeric polymer can comprise an acrylic polymer. In another aspect, at least one of the mesh and the second mesh can comprise a woven glass fiber. In yet another aspect, the mesh can comprise a first woven glass fiber comprising a first plurality of warp strands and a first plurality of weft strands, and the second mesh can comprise a second woven glass fiber comprising a second plurality of warp strands and a second plurality of weft strands, and wherein the first plurality of warp strands are aligned biased to the second plurality of warp strands within the reinforcement layer. In another aspect, the substrate can comprise a joint, wherein the joint has a joint length and a joint width and wherein the first fluid-applied coating covers at least a portion of the joint. In still a further aspect, the first fluid-applied coating can be disposed in at least a portion of the joint. In yet another aspect, the mesh can comprise a woven fiber and a plurality of warp strands and a plurality of weft strands, and wherein at least one of the plurality of warp strands and the plurality of weft strands can be oriented perpendicular to the length of the joint. In still a further aspect, the mesh can comprise a woven fiber and a plurality of warp strands and a plurality of weft strands, and wherein at least one of the plurality of warp strands and the plurality of weft strands can be oriented at an acute angle to the length of the joint. In a further aspect, the mesh of the reinforcement layer can comprise a woven fiber. In still a further aspect, the mesh can exhibit an area density in the range of about 200 g/m² to about 750 g/m². In another aspect, the mesh can exhibit an area density in the range of about 250 g/m² to about 600 g/m². In another aspect, the mesh can exhibit an area density in the range of about 350 g/m² to about 550 g/m². In a further aspect, the mesh can exhibit an area about 373 g/m². In yet another aspect, the mesh can comprise a warp and a weft, and wherein the warp and the weft can form an angle of about 90°. In a further aspect, the warp and the weft can form an angle greater than 90°. In still another aspect, the warp and the weft can form an angle of about 45°. In another aspect, at least one of the first fluid-applied coating and the second fluid-applied coating can comprise an elastomeric polymer. In a further aspect, the elastomeric polymer can comprise an acrylic polymer. In yet a further aspect, at least one of the first fluid-applied coating and the second fluid-applied coating can comprise a latex-modified Portland cement material. In still a further aspect, at least one of the first fluid-applied coating and the second fluid-applied coating can comprise a silyl-terminated polyether polymer. In one aspect, the substrate can comprise a wood cover. In another aspect, the substrate can comprise a masonry material. In a further aspect, the reinforcement layer can comprise a plurality of reinforcement strips extending between the top and the base of the surface, and wherein the plurality of reinforcement strips can comprise the first fluid-applied coating, the mesh and the second fluid-applied coating. In still another aspect, at least two of the plurality of reinforcement strips can overlap. In another aspect, the reinforcement layer covers a majority of the surface of the substrate.

In another alternative embodiment, the present disclosure encompasses a method of reinforcing a structure against shear forces comprising the steps of applying a first fluid-applied coating to a surface of a substrate of a structure; applying a mesh to the first fluid-applied coating, wherein the first fluid-applied coating adheres the mesh to the surface of the substrate, and wherein the mesh exhibits an area density of at least about 200 g/m²; applying a second fluid-applied coating to the mesh and the first fluid-applied coating; and, curing the first fluid-applied coating and the second fluid-applied coating to form a reinforcement layer. In another aspect, curing or drying can have a time period of at least 15 days. In a further aspect, the surface has a height, and wherein the reinforcement layer can extend along a majority of the height of the surface. In yet another aspect, the method further can comprise applying a second mesh to the second fluid-applied coating. In still a further aspect, the method can comprise applying a third fluid-applied coating to the second mesh. In another aspect, at least one of the first fluid-applied coating and the second fluid-applied coating can comprise an elastomeric polymer. In a further aspect, the reinforcement layer can comprise a plurality of strips. In another aspect, applying the mesh further can comprise orienting a warp at an angle perpendicular to a joint formed in the substrate.

In still a further alternative embodiment, the present disclosure encompasses a reinforcement layer, a system for structural reinforcement, a method of structural reinforcement, a reinforced structure in accordance with any of the preceding embodiments and/or aspects.

In still a further alternative embodiment, the present disclosure encompasses a reinforcement layer, a system for structural reinforcement, a method of structural reinforcement, a reinforced structure in accordance with any of the preceding embodiments and/or aspects and wherein any one or more of the reinforcement layers are disposed on opposing surfaces of a wall.

These and other aspects are encompassed by the present disclosure and set forth in more particularity in the detailed description below and the accompanying drawings that are briefly described as follows.

### BRIEF DESCRIPTION OF THE DRAWINGS

FIG. 1 illustrates a side elevation view of a wood shear wall with a portion of the cover cutaway.

FIG. 2 illustrates a side elevation view of the wood shear wall shown in FIG. 1 with a first fluid-applied coating applied to each joint and encompassing aspects of the present disclosure.

FIG. 3 illustrates a side elevation view of the wood shear wall shown in FIG. 2 with a mesh layer disposed on the first fluid-applied coating and encompassing aspects of the present disclosure.

FIG. 4 illustrates a side elevation view of the wood shear wall shown in FIG. 3 with a second fluid-applied coating disposed on the mesh and the first fluid-applied coating and encompassing aspects of the present disclosure.

FIG. 5 illustrates a perspective view of a portion of a wood shear wall with portions of the reinforcement strip cutaway and encompassing aspects of the present disclosure.

FIG. 6 illustrates a side elevation view of a portion of a wood shear wall with a reinforcement layer encompassing aspects of the present disclosure disposed on a joint of the wood shear wall and with portions of the reinforcement layer cutaway.

FIG. 7 illustrates a side elevation view of a portion of a wood shear wall with a another reinforcement layer encompassing aspects of the present disclosure disposed on a joint of the wood shear wall and with portions of the reinforcement layer cutaway.

FIG. 8 illustrates a side elevation view of a portion of a wood shear wall with a yet another reinforcement layer encompassing aspects of the present disclosure disposed on a joint of the wood shear wall and with portions of the reinforcement layer cutaway.

FIG. 9 illustrates a side elevation view of a portion of a wood shear wall with a still another reinforcement layer encompassing aspects of the present disclosure disposed on a joint of the wood shear wall and with portions of the reinforcement layer cutaway.

FIG. 10 illustrates a perspective view of a portion of a wood shear wall with still a further reinforcement layer encompassing aspects of the present disclosure disposed on the wall and portions of the reinforcement layer cutaway.

FIG. 11 is a side elevation view of a shiplap wall with a reinforcement layer encompassing aspects of the present disclosure disposed on the wall and portions of the reinforcement layer cutaway.

FIG. 12 is a side elevation view of a masonry wall with a reinforcement system encompassing aspects of the present disclosure disposed thereon and portions of the reinforcement system cutaway.

FIG. 13 is a side elevation view of a masonry wall with another configuration of a reinforcement system encompassing aspects of the present disclosure disposed thereon and portions of the reinforcement system cutaway.

FIG. 14 is a side elevation view of a masonry wall with yet another configuration of a reinforcement system encompassing aspects of the present disclosure disposed thereon and portions of the reinforcement system cutaway.

The drawings and other aspects of the present disclosure will be discussed in greater detail herein below.

### DETAILED DESCRIPTION

As used herein, the phrase “at least one” includes all numbers of one and greater than one. As used herein, the phrase “at least” followed by a number includes that number and all number greater than that number. As used herein, the singular forms of “a,” “an,” and “the” also encompass the plural forms thereof unless otherwise indicated. The ranges used herein include all values that would fall within the stated range, including values falling intermediate of whole values. As used herein, the term “and/or” refers to one or all of the listed elements or a combination of any two or more of the listed elements. As used herein, the values described as “% by weight” are calculated on the weight of the composition in which the component is found. As used herein, the term “plurality” encompasses a number greater than one. As used herein, the terms “cover” and “sheath” are interchangeable and refer to a panel or sheet that is used on a wall assembly to form a major wall surface. As used herein, the term “fluid-applied” describes a material that is applied to a substrate as a fluid and exhibits, prior to curing, fluid-like properties, in that it does not resist shear force applied thereto, at the time it is applied to the surface. As used herein, the term “bias” refers to a non-parallel line of orientation. As used herein, the term “area density” refers to the average mass per unit area of an object that is typically measured in two dimensions.

The present disclosure encompasses systems and methods for structural reinforcement. The systems and methods of structural reinforcement of the present disclosure potentially can be used to enhance the resistance of a substrate, wall, building or other structure to shear and lateral forces applied thereto, such as those generated by earthquakes, high winds, and hurricanes. The present disclosure also encompasses systems and methods of reinforcement of wall systems, including, but not limited to wooden shear walls, diaphragms, shiplap walls, wall-to-floor-to wall interfaces and masonry systems, formed of brick, concrete, concrete block, stone, stucco, and the like. The present disclosure also encompasses and is directed to systems and methods for producing wall assemblies that exhibit enhanced resistance to shear forces as compared to wall assemblies that do not have formed thereon the reinforcement layers encompassed by the present disclosure. In some embodiments of the present disclosure, increases in strength, stiffness, ductility and/or energy absorption capacities of wood-framed walls, diaphragms, shiplap walls and/or masonry walls in response to shear and lateral stresses have been shown. In certain embodiments, the systems and methods of the present disclosure can allow a wall to withstand a shear force and deform in so doing and return to its original orientation with reduced incidence of breaking, cracking, or breaching a weather resistive barrier and/or water resistive barrier and/or air barrier and/or moisture barrier or combinations thereof formed on the wall, wherein the systems and methods can include reinforcement layers that comprises one or more of such barriers.

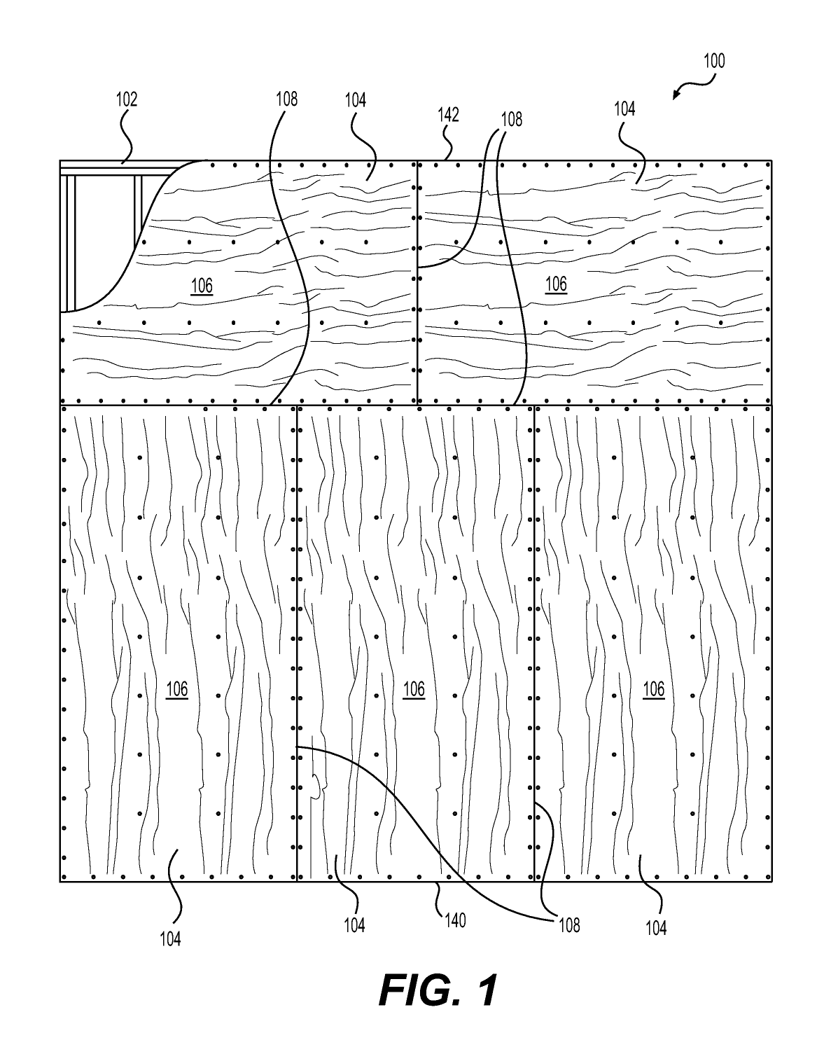

FIGS. 1-14 illustrate various aspects of the present disclosure. FIG. 1 illustrates a typical shear wall 100 having a base 140 and a top 142 and a height between the base 140 and the top 142. The shear wall 100 includes a frame 102 to which is attached a plurality of covers 104. The covers 104 can be formed of plywood, oriented strand board, concrete panels, cement boards, glass bead boards, glass bead composite boards, and/or other known materials. The covers 104 are aligned adjacent to each other on the frame 100 to form the surface 106 of the wall 100. The covers 104 form a plurality of joints 108 there between.

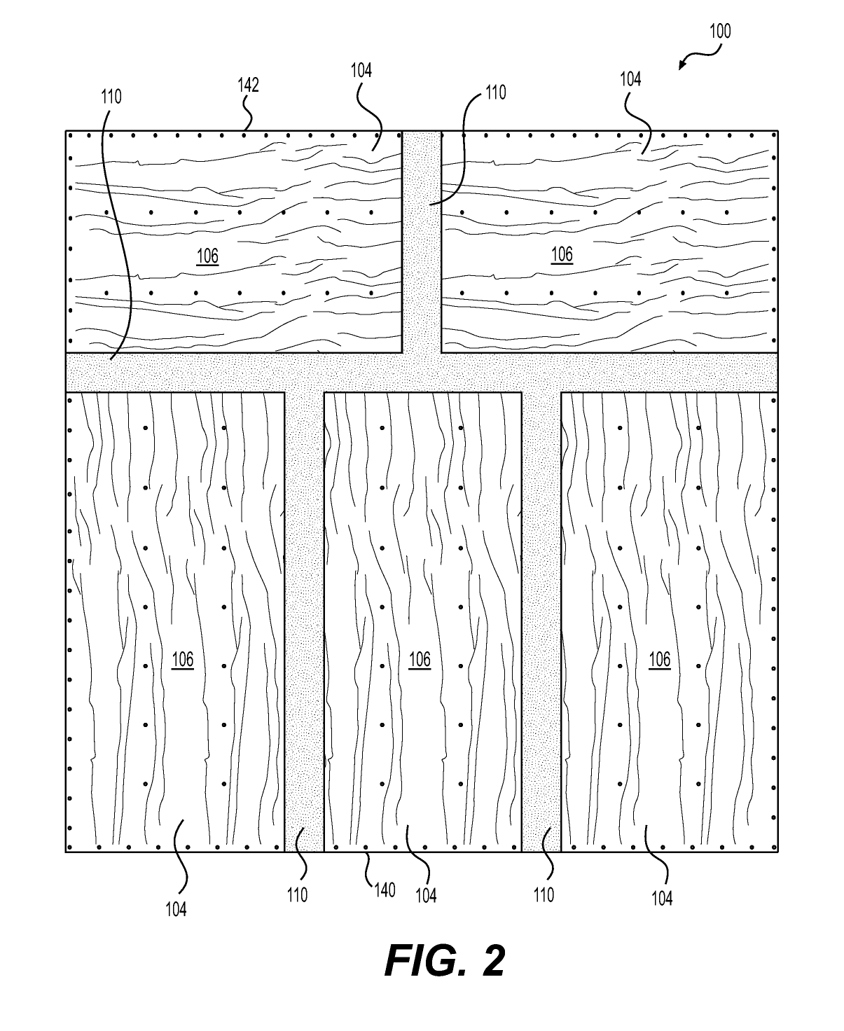

FIG. 2 shows the shear wall 100 illustrated in FIG. 1 with a first fluid-applied coating 110 disposed along the joints 108 between the covers 104 of the shear wall 100. The first fluid-applied coating 110 covers a portion of the outer surface 106 of each cover adjacent a joint 108. The first fluid-applied coating 110 can extend along all or a portion of each joint 108 and generally extends equidistant beyond the edge of each joint 108 onto surface 106 of the adjoining covers 104, and can extend along all or a majority of the height of the surface 106. The width of the first fluid-applied coatings 110 can vary depending upon the resiliency of the composition of the first fluid-applied coating 110 and the desired performance. In one aspect, the first fluid-applied coating 110 can have a total width of approximately 0.3 m with the joint 108 centrally aligned thereunder.

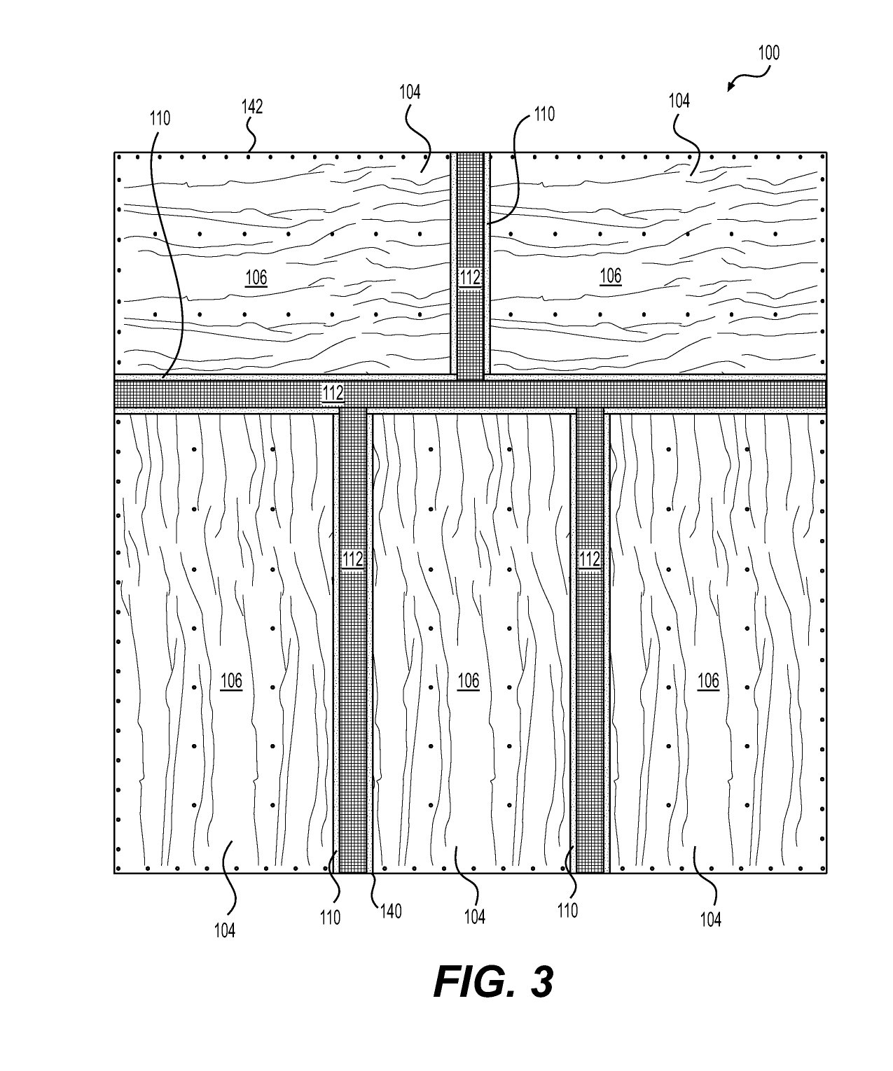

FIG. 3 shows the shear wall 100 shown in FIG. 2 with a mesh 112 disposed on the first fluid-applied coating 110. The mesh 112 can be aligned over each joint 108 so that a portion of the mesh 112 extends equidistant beyond the joint over a portion of each adjoining cover 104. The mesh 112 can extend along all or a portion of each joint 108. The mesh 112 can be as wide as or less than the width of the first fluid-applied coating 110. The mesh 112 is embedded in the first fluid-applied coating 110 and is adhered to the surface 106 by the first fluid-applied coating 110. The mesh 112 can exhibit an area density of at least about 200 g/m² to provide sufficient tensile strength to resist lateral forces. Alternatively, the mesh 112 can exhibit an area density in a range of about 200 g/m² to about 750 g/m² to provide sufficient tensile strength to resist lateral forces.

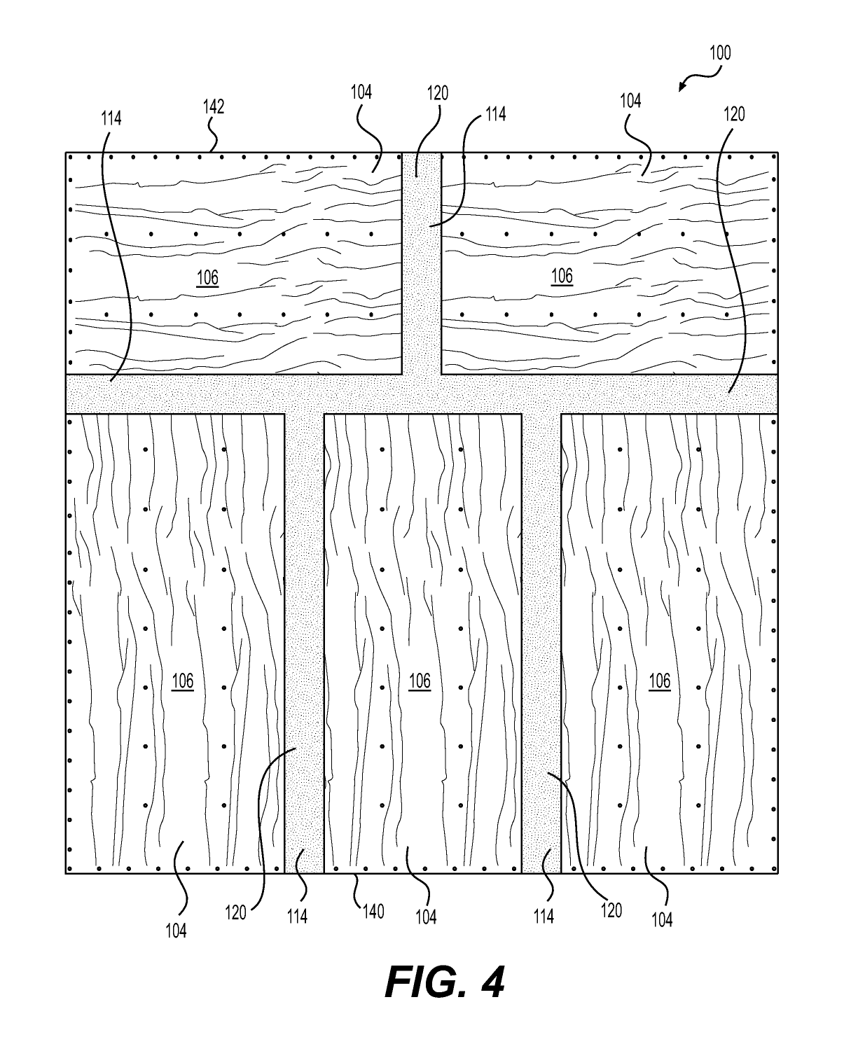

FIG. 4 shows the shear wall 100 shown in FIG. 3 with a second fluid-applied coating 114 disposed on the mesh 112 and the first fluid-applied coating 110. The second fluid-applied coating 114 can be as wide as the first fluid-applied coating 110 and can have a thickness sufficient to completely cover the mesh 112. In one aspect, the combined depths of the first and second fluid-applied coatings 110 and 114 are greater than the depth of the mesh 112, such that the outer surface of the second fluid-applied coating 114 covers the mesh 112. The first fluid-applied coating 110, the mesh 112 and the second fluid-applied coating 114 cooperate to form a reinforcement layer 120 that can tend to reinforce the shear wall 100 so as to enhance the resistance of the shear wall 100 to shear and lateral forces, such as those generated by high winds, hurricanes and earthquakes. The reinforcement layer 120 extends along the entire height of the surface 106 of the wall 100 and is formed of a plurality of reinforcement strips.

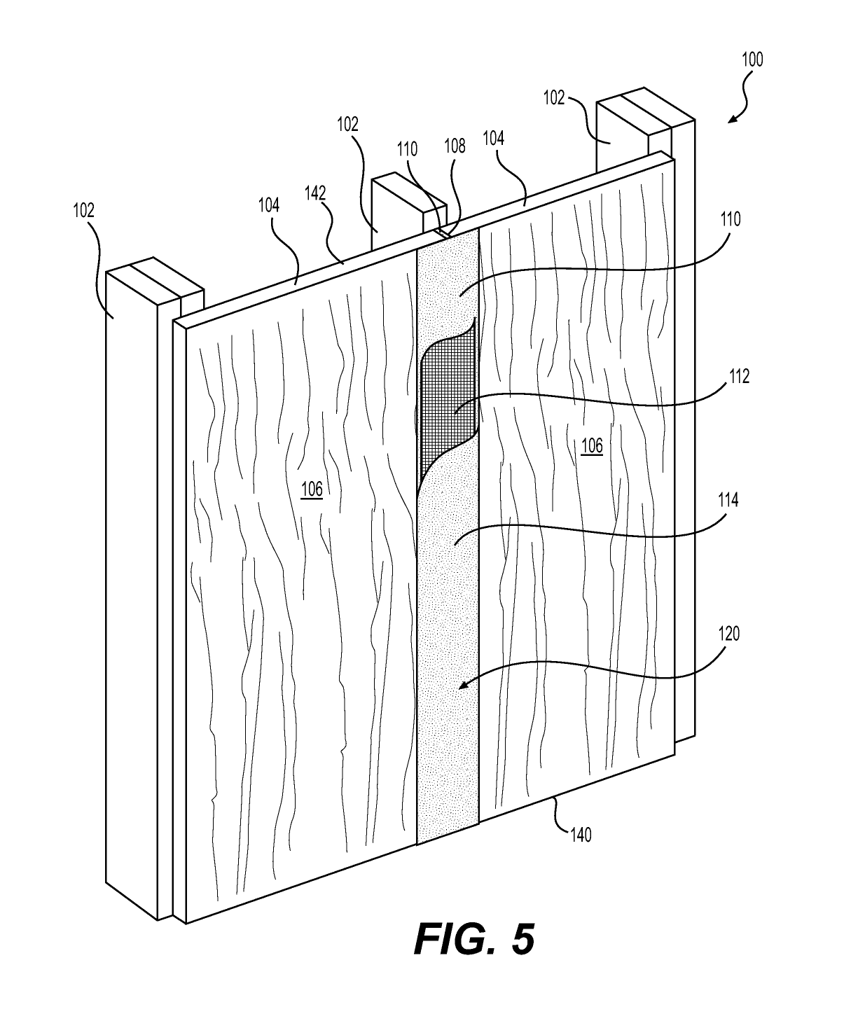

FIG. 5 illustrates a portion of a shear wall 100 and shows a portion of a reinforcement strip of the reinforcement layer 120 disposed over a joint 108 and extending along the height of the surface 106 of the wall 100 from the base 140 to the top 142. The first fluid-applied coating 110 can be seen to penetrate and be disposed in the joint 108 between the adjacent covers 104, as well as extending over the outside of the joint 108 and a portion of each adjoining cover 104. The mesh 112 and the second fluid-applied coating 114 are likewise disposed over the joint 108 and portions of each cover 104. The deposition of the first fluid-applied coating 110 into the joint 108 and between the covers 104 can tend to adhere the adjoining covers 104 to each other and the mesh 112 to the wall 100, thereby potentially further reinforcing the wall 100.

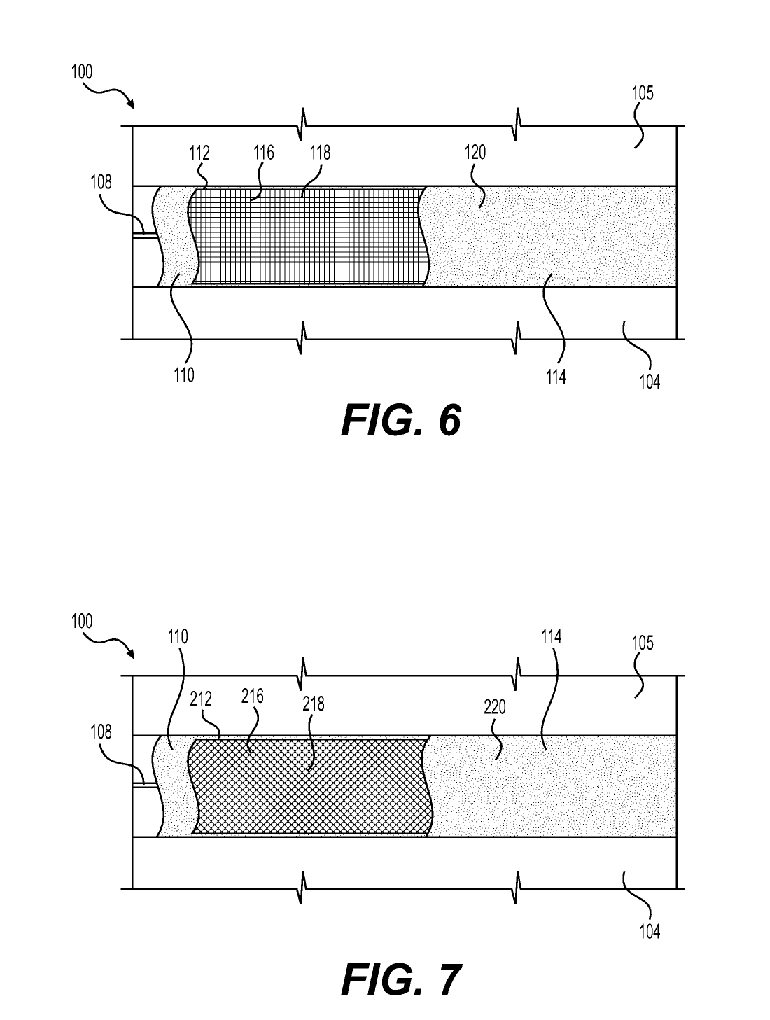

FIG. 6 illustrates a section of a shear wall 100 that includes a reinforcement layer 120 disposed over a joint 108 formed between two adjacent covers, a first cover 104 and a second cover 105, of the shear wall 100. The reinforcement layer 120 includes a first fluid-applied coating 110 disposed over and in the joint 108 and extending over a portion of each of the adjacent first and second covers 104 and 105, respectively. A mesh 112 is disposed as a strip over the first fluid-applied coating 110 and extends along the joint 108. The mesh 112 comprises a woven glass fiber having a warp 116 and a weft 118. The mesh 112 exhibits an angle of orientation between the warp 116 and the weft 118 of about 90°. The warp 116 of the mesh 112 is aligned generally perpendicular to the length of the joint 108, while the weft 118 of the mesh 112 is aligned generally parallel to the length of the joint 108. A second fluid-applied coating 114 is disposed over the mesh 112 and has a width approximately the same as that of the first fluid-applied coating 110. The reinforcement layer 120 comprises the first fluid-applied coating 110, the mesh 112 and the second fluid-applied coating 114. A shear wall 100 can have a plurality of reinforcement strips covering a plurality of joints 108 formed therein and thereby forming a reinforcement layer 120 on the wall 100.

FIG. 7 shows a section of a shear wall 100 that includes a strip of another reinforcement layer 220 disposed over a joint 108 formed between two adjacent covers, a first cover 104 and a second cover 105, of the shear wall 100. The reinforcement layer 220 includes a first fluid-applied coating 110 disposed over and in the joint 108 and extending over a portion of each of the adjacent first and second covers 104 and 105, respectively. A mesh 212 is disposed as a strip over the first fluid-applied coating 110 and extends along the joint 108. The mesh 212 comprises a woven glass fiber having a warp 216 and a weft 218. The mesh 212 exhibits an angle of orientation between the warp 216 and the weft 218 of about 90°, but the warp 216 is not aligned perpendicular to the length of the mesh. Rather, the warp 216 and the weft 218 are aligned at an angle of about 45° relative to the length of the mesh 212. Accordingly, the warp 216 and the weft 218 of the mesh 212 are aligned at an angle of about 45° relative to the length of the joint 108. A second fluid-applied coating 114 is disposed over the mesh 212 and has a width approximately the same as that of the first fluid-applied coating 110. The reinforcement layer 220 comprises the first fluid-applied coating 110, the mesh 212 and the second fluid-applied coating 114. A shear wall 100 can have a plurality of reinforcement strips covering a plurality of joints 108 formed therein with the mesh 312 oriented as shown in FIG. 7, and thereby forming a reinforcement layer 220 on the wall 100.

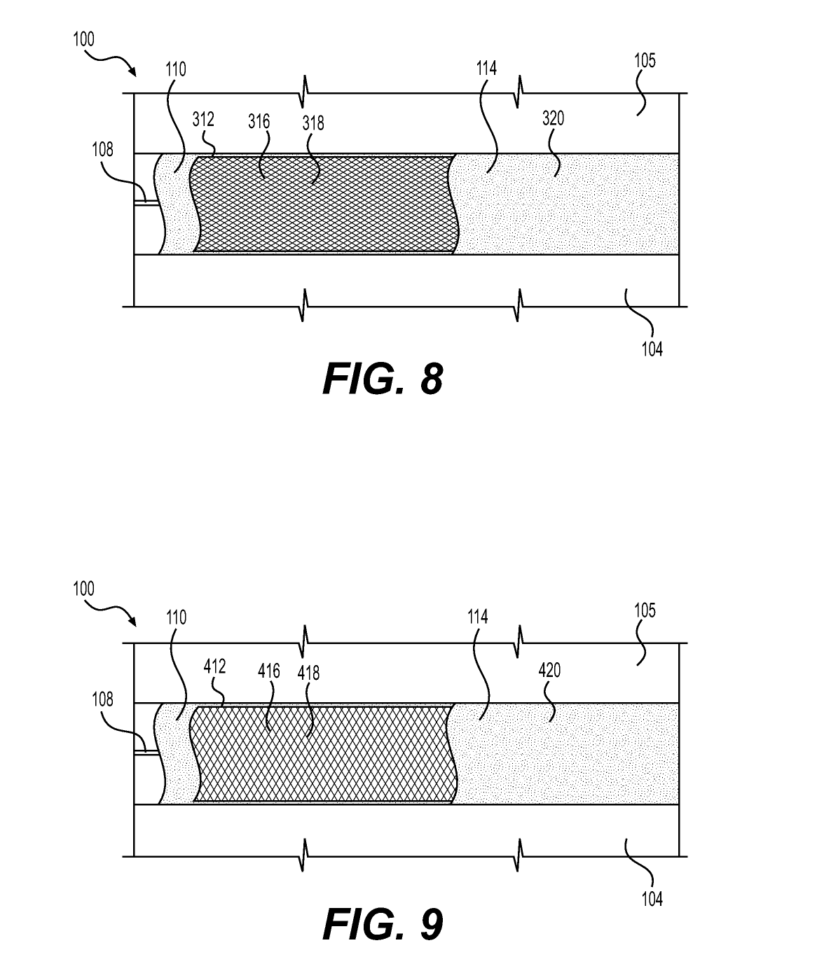

FIG. 8 is yet another view showing a section of a shear wall 100 that includes yet another reinforcement layer 320 disposed over a joint 108 formed between two adjacent covers, a first cover 104 and a second cover 105, of the shear wall 100. The reinforcement layer 320 includes a first fluid-applied coating 110 disposed over and in the joint 108 and extending over a portion of each of the adjacent first and second covers 104 and 105, respectively. A mesh 312 is disposed as a strip over the first fluid-applied coating 110 and extends along the joint 108. The mesh 312 comprises fiber having a warp 316 and a weft 318. The warp 316 and the weft 318 are aligned such that the supplementary angles formed thereby do not equal 90°, but rather include a major angle greater than 90° and a minor angle less than 90°. The mesh 312 is aligned with the vertices of the major angles aligned perpendicular to the length of the joint 108. A second fluid-applied coating 114 is disposed over the mesh 312 and has a width approximately less than or equal to that of the first fluid-applied coating 110. The reinforcement layer 320 comprises the first fluid-applied coating 110, the mesh 312 and the second fluid-applied coating 114.

FIG. 9 is still a further view showing a section of a shear wall 100 that includes still another configuration of a reinforcement layer 420 disposed over a joint 108 formed between two adjacent covers, a first cover 104 and a second cover 105, of the shear wall 100. The reinforcement layer 420 includes a first fluid-applied coating 110 disposed over and in the joint 108 and extending over a portion of each of the adjacent first and second covers 104 and 105, respectively. A mesh 412 is disposed as a strip over the first fluid-applied coating 110 and extends along the joint 108. The mesh 412 comprises fiber having a warp 416 and a weft 418. The warp 416 and the weft 418 are aligned such that the supplementary angles formed thereby do not equal 90°, but rather include a major angle greater than 90° and a minor angle less than 90°. The mesh 412 is aligned with the vertices of the major angles aligned parallel to the length of the joint 108. A second fluid-applied coating 114 is disposed over the mesh 412 and has a width approximately less than or equal to the width of the first fluid-applied coating 110. The reinforcement layer 420 comprises the first fluid-applied coating 110, the mesh 412 and the second fluid-applied coating 114.

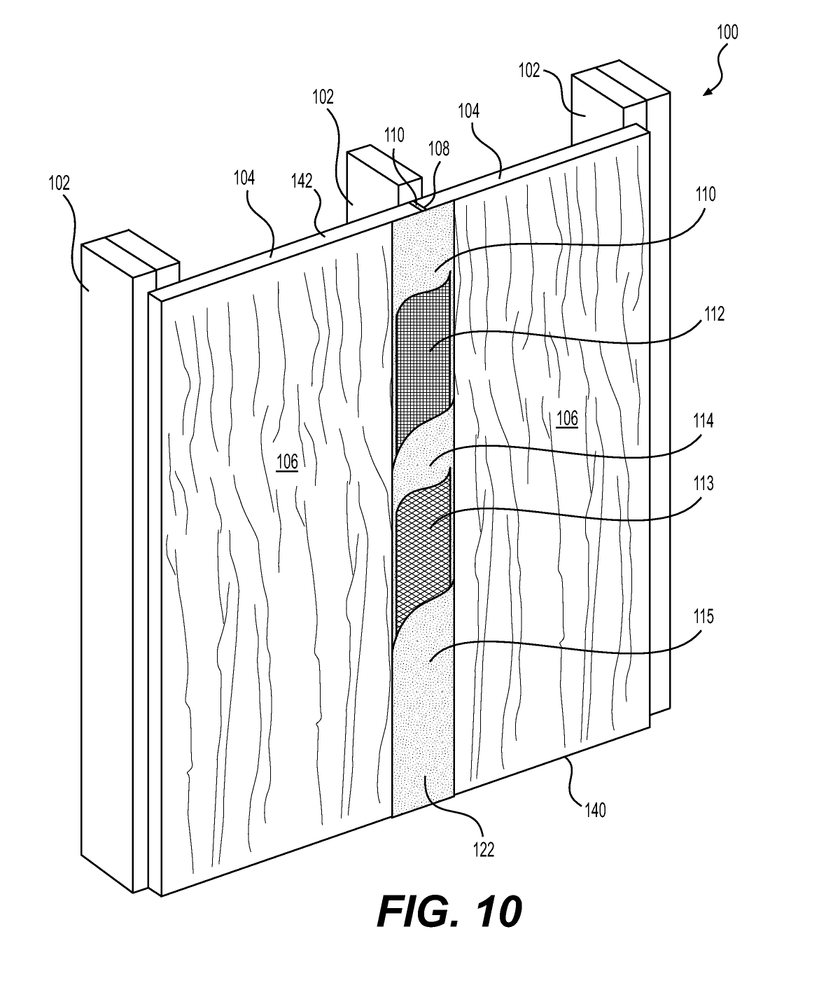

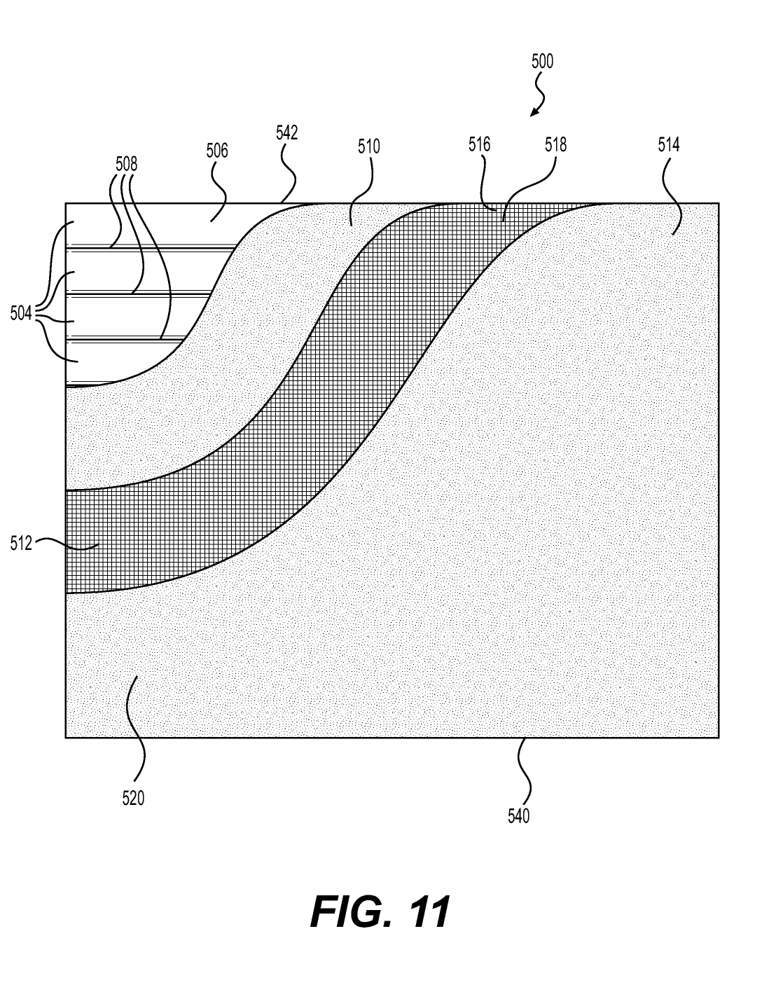

FIG. 10 illustrates another embodiment of a reinforcement layer 122 encompassed by the present disclosure. A portion of a shear wall 100 is shown that includes a frame 102 to which are attached a plurality of covers 104 that define a joint 108 there between and that form a substrate with a surface 106 that has a base 140 and a top 142. The wall 100 has a reinforcement layer 122 disposed on the surface 106 over the joint 108 and extends from the base 140 to the top 142. The reinforcement layer 122 includes a first fluid-applied coating 110 disposed over and into the joint 108. A portion of the first fluid-applied coating 110 is disposed between the edges of the adjoining covers 104 in the joint 108, while other portions of the first fluid-applied coating 110 extend over the outside of the joint 108 and a portion of each of the covers 104. The reinforcement layer 122 also includes a first mesh 112 disposed on the first fluid-applied coating 110. The first mesh 112 is adhered to the wall 100 by the first fluid-applied coating 110 and a second fluid-applied coating 114 disposed on the first fluid-applied coating 110 and the first mesh 112. The reinforcement layer 122 also includes a second mesh 113 disposed on the second fluid-applied coating 114 and a third fluid-applied coating 115 disposed on the second mesh 115 and the second fluid-applied coating 114. The second mesh 113 is also adhered to the wall 100 by the first, second and third fluid-applied coatings 110, 112 and 115, respectively. The first mesh 112 and the second mesh 115 can be any configuration of meshes set forth in FIGS. 6-9, as well as alternative woven and non-woven configurations, and are shown in FIG. 10 with different orientations of the warp and weft relative to the length of the joint 108. Alternatively, the first mesh 112 and the second mesh 115 can be the same orientation and aligned in the same orientation on the same on the wall 100.

FIG. 11 illustrates a shiplap wall 500 formed of a plurality of planks 504 forming a surface 506 of a substrate of the shiplap wall 500. Between each plank 504 is formed a joint 508 and the shiplap wall 500 includes a plurality of joints 508 formed therein. The surface 506 includes a base 540 and a top 542. A reinforcement layer 520 is disposed on and adhered to the surface 506 of the shiplap wall 500 and includes a first fluid-applied coating 510 disposed across the surface 506 of the shiplap wall 500. Over the first fluid-applied coating 510 is disposed a mesh 512 that is adhered to the shiplap wall 500 by the first fluid-applied coating 510 and extends over the entire surface 506. Over the first fluid-applied coating 510 and the mesh 512 is disposed a second fluid-applied coating 514 that also extends over the surface 506 of the shiplap wall 500. The mesh 512 includes a warp 516 and a weft 518 that form an angle of about 90°. The strands of the warp 516 are oriented generally perpendicular to the joints 508 and the strands of the weft 518 are oriented generally parallel to the joints 508. While the reinforcement layer 520 is illustrated as extending over the entire area of the surface 506 of the shiplap wall 500, the present disclosure also encompasses systems that cover less than the entire wall. In one aspect, the reinforcement layer can extend over a majority of the area of the surface of the wall. In another aspect, the reinforcement layer can extend over a majority of the height of the surface of the wall.

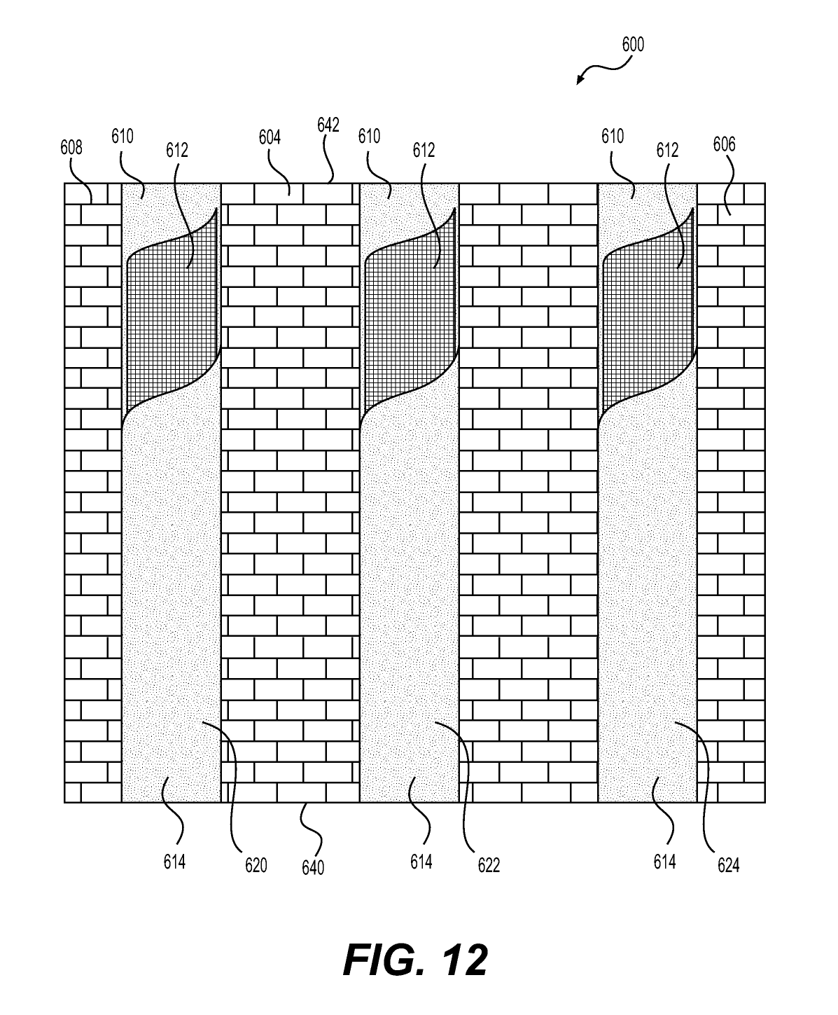

Another aspect of the present disclosure encompasses systems for structural reinforcement that can be applied to masonry structures formed of brick, concrete, concrete block, stone, stucco or other known masonry materials. FIG. 12 illustrates a masonry wall 500 that is formed of a plurality of masonry units 604 that form a surface 606 of the wall 600. The masonry units illustrated in the drawings can be any known unit of construction used in masonry structures, such as, but not limited to, bricks, concrete blocks, stones and other known materials. The masonry units 604 are aligned in the wall 600 to form a plurality of joints 608. On the surface 606 of the wall 600 are disposed a plurality of reinforcement strips 620, 622 and 624. Each reinforcement strip 620, 622 and 624 is aligned vertically on the wall 600, spaced apart from the other reinforcement strips, and extends along a majority of the height of the surface 606 from the base 640 to the top 642 of the surface 606. Each reinforcement strip 620, 622, and 624 includes a first fluid-applied coating 610 applied to the surface 606 of the wall 600 and which extends the entire height of the wall 600. A mesh 612 is disposed on and adhered to the first fluid-applied coating 610 of each reinforcement strip 620, 622 and 624. The width of each mesh 612 is less than or equal to the width of each first fluid-applied coating 610. Each mesh 612 extends approximately the same height as each first fluid-applied coating 610. Each mesh 612 can have the orientation of warp and weft of any one of the meshes set forth in FIGS. 6-9, or another configuration of woven or non-woven mesh. Each reinforcement strip 620, 622 and 624 also includes a second fluid-applied coating 614 applied to each mesh 612 and first fluid-applied coating 610. Each second fluid-applied coating 614 has the same chemical composition, width and length as each first fluid-applied coating 610. The reinforcement strips 620, 622 and 624 cooperate to form a reinforcement layer on the surface 606 of the wall 600. The wall 600 can have another face opposing the surface 606 to which are applied one or more reinforcement strips as described herein, thereby forming a double-sided system for reinforcing masonry walls.

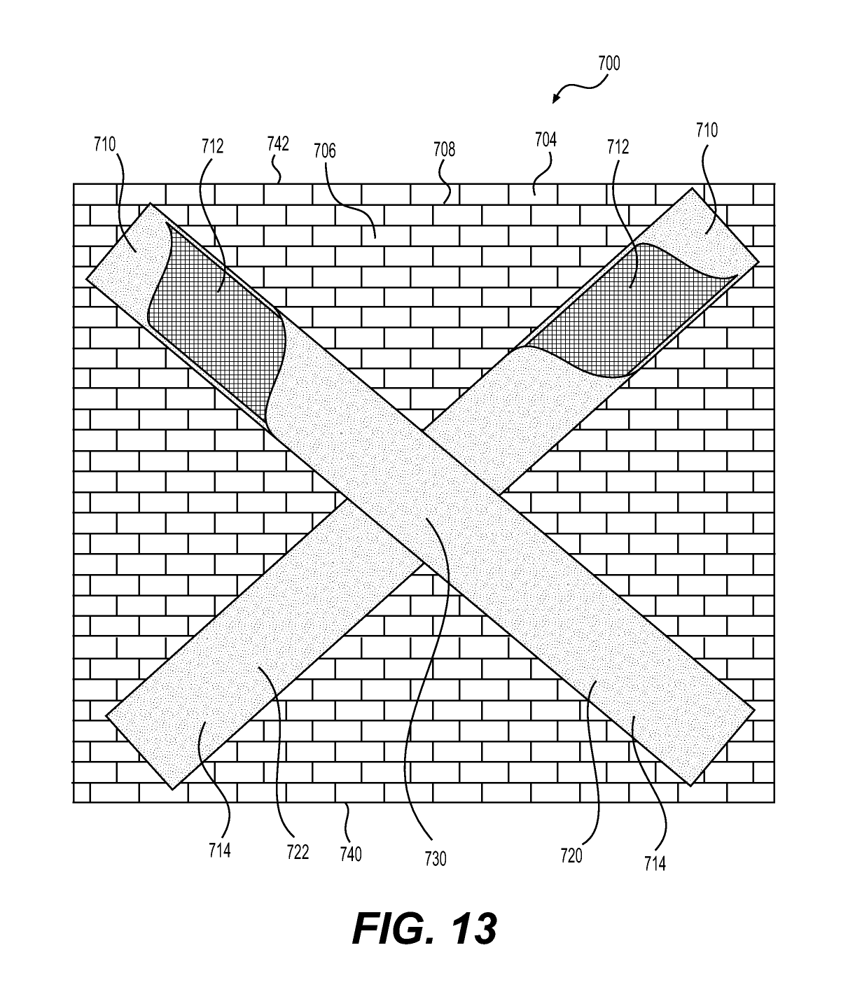

FIG. 13 illustrates yet another configuration of a reinforcement system encompassed by the present disclosure. A masonry wall 700 formed of a plurality of masonry units 704 is provided with a surface 706 in which is formed a plurality of joints 708. On the surface 706 are applied two reinforcement strips 720 and 722 that overlap. Each reinforcement strip 720 and 722 includes a first fluid-applied coating 710. The first fluid-applied coating 710 of the first reinforcement strip 722 is applied and adhered to the surface 706 of the masonry wall 600. Over the first fluid-applied coating 710 is disposed a mesh 712 that is adhered to the wall 700 by the first fluid-applied coating 710. The mesh 712 has a width less than or equal to the width of the first fluid-applied coating 710 and a length less than or equal to the length of the first fluid-applied coating 710. A second fluid-applied coating 714 is applied over and adheres to the first fluid-applied coating 710 and the mesh 710. The second reinforcement strip 720 is applied over both a portion of the first reinforcement strip 720 and the surface 706 of the wall 700. The second reinforcement strip 720 includes a first fluid-applied coating 710 applied and adhered to the masonry units 704 of the surface 706 of the wall 700 and a portion of the first reinforcement strip 722. A mesh 712 of the second reinforcement strip 720 is applied to the first fluid-applied coating 710 of the second reinforcement strip 720 and also has a width less than or equal to the first fluid-applied coating 710 and a length less than or equal to the length of the first fluid-applied coating 710. A second fluid-applied coating 714 of the second reinforcement strip 720 is applied over the mesh 712 and the first fluid-applied coating 710 of the second reinforcement strip 720. The second reinforcement strip 720 overlaps a portion of the first reinforcement strip 722 forming a double reinforced section 730 aligned near the center of the surface 706 of the wall 700. The double reinforced section 730 includes two layers of mesh 712 and up to four coatings, two each of the first fluid-applied coatings 710 and the second fluid-applied coatings 712. The first fluid-applied coatings 710 and the second fluid-applied coatings 712 can have the same chemical composition, widths and lengths. The wall 700 can have an opposed surface that also has two overlapping reinforcement strips as described herein disposed thereon. The reinforcement strips 720 cover a plurality of masonry units 704 and joints 708 and cooperate to form a reinforcement layer on the surface 706 of the wall 700. Another alternative configuration, not shown, provides the first reinforcement strip aligned as illustrated in FIG. 13, but with a second reinforcement strip disposed on the opposing face of the masonry wall. The second reinforcement strip is aligned diagonally on the wall like the first strip, thereby forming a reinforcement layer on each side of the wall.

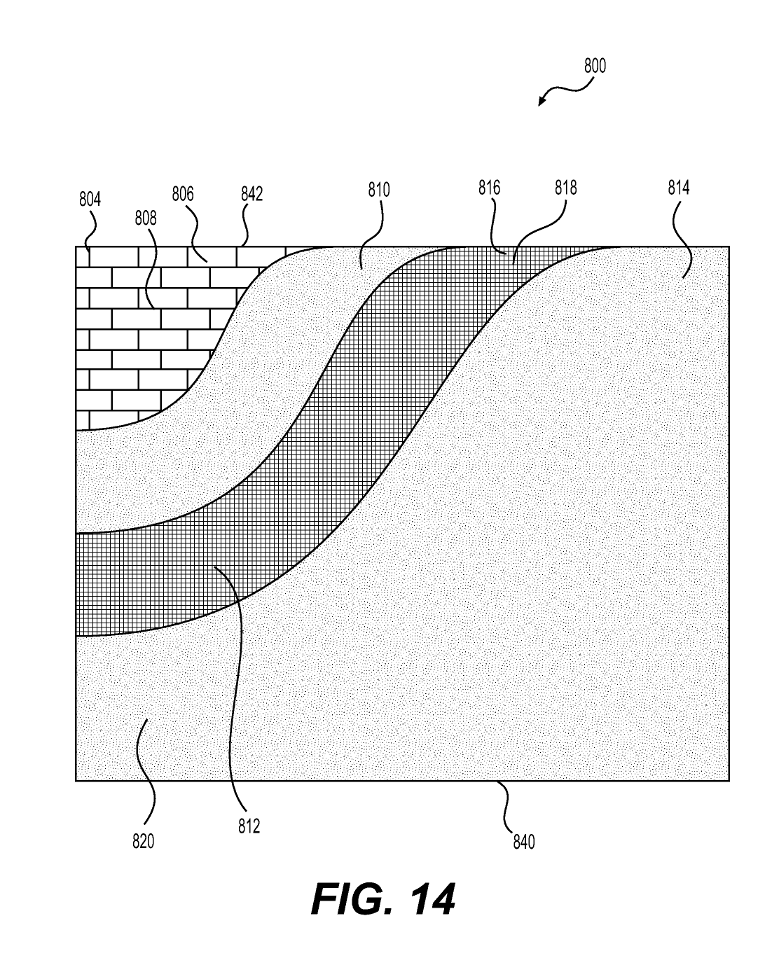

FIG. 14 illustrates still another embodiment of the reinforcement systems encompassed by the present disclosure and shows a masonry wall 800 formed of a plurality of masonry units 804 configured to form a surface 806 of the wall 800 in which is formed a plurality of joints 808 between the masonry units 804. To the surface of the face 806 of the wall 800 is applied a reinforcement layer 820 that covers the entire surface 806. The reinforcement layer 820 comprises a first fluid-applied coating 810 applied and adhered to the masonry units 804. A mesh 812 is disposed on the first fluid-applied coating 810 and adhered to the wall 800 by the first fluid-applied coating 810. A second fluid-applied coating 814 is applied to the mesh 812 and the first fluid-applied coating 810. The mesh 812 extends over an area less than or equal to an area covered by the first fluid-applied coating 810. The second fluid-applied coating 814 extends over an area equal to the area covered by the first fluid-applied coating 810. The wall 800 can have a second reinforcement layer applied to the opposing face thereof. The reinforcement strips and systems illustrated in the drawings can include more than two layers of coatings and meshes to provide the desired performance characteristics. Indeed, any of the reinforcement layers illustrated in the drawings and/or disclosed herein can be used in combination with any one or more of the same or differently illustrated and described reinforcement layers on the same or opposing faces of a surface, wall or other part of a structure to structural reinforce such substrate.

The fluid-applied coatings used in the reinforcement systems and methods encompassed by the present disclosure can include various compounds and mixtures of compounds. Each of the first, second, and third fluid-applied coatings illustrated in the drawings and described herein are fluid-applied coatings that can include one or more of the compounds described herein. The fluid-applied coatings that form a reinforcement layer can be the same or different from the other fluid-applied coatings making up the reinforcement layer. In one aspect, the fluid-applied coatings can comprise an elastomeric, acrylic polymer compound. In another aspect, the fluid-applied coatings can be water based in their application state. In still another aspect, the coating can comprise an air and moisture barrier coating. In another aspect, the coating can exhibit, after curing, flexibility without failure at a temperature of less than about −26° C. In yet another aspect, the coating can exhibit, after curing, a glass transition temperature of less than −17° C. In still another aspect, the coating can comprise one or more compounds selected from an acrylic elastomer, a rubber elastomer, a styrene-acrylic elastomer, a urethane polymer, a silyl-terminated polyether polymer, a siloxane polymer, a latex and/or combinations thereof. The fluid applied coatings can comprise a water-based acrylic elastomer material, such as StoGuard Shear, Sto Gold Fill®, and Sto Flexible Skim Coat, a water-based acrylic polymer material, such as Sto RFP, and/or a silyl-terminated polyether material, such as StoGuard® RapidFill, and/or a water-based latex fluid-applied coating, such as Sto Gold Coat®, and/or a latex-modified Portland cement based material, such as Sto Flexyl and Sto Watertight Coat, all of which are available from Sto Corp. of Atlanta, Ga., United States.

The fluid-applied coating encompassed by the present disclosure can include a mixture of compounds selected from 1,2-propanediol, acrylic polymer, crystalline silica, muscovite mica, and water. The fluid-applied coating can include 1,2-propanediol in the range of about 1% to about 5% by weight, acrylic polymer in the range of about 10% to about 30% by weight, crystalline silica in an amount greater than about 60% by weight, mica in the range of about 1% to about 5% by weight, and/or water in the range of about 10% to about 30% by weight. In another aspect, the fluid-applied coating can include a mixture of compounds selected from 1,2-propanediol, aluminum silicate, crystalline silica, naphtha, titanium oxide, water, and a styrene-butadiene copolymer. The fluid-applied coating can include a mixture comprising 1,2-propanediol in a range of about 1% to about 5% by weight, aluminum silicate in a range of about 1% to about 5% by weight, crystalline silica in a range of about 30% to about 60% by weight, naphtha in a range of about 1% to about 5% by weight, titanium dioxide in a range of about 1% to about 5% by weight, and/or water dispersed styrene-butadiene copolymer in a range of about 30% to about 60% by weight. In still a further aspect, the fluid-applied coating can include one or more compounds selected from mica, silicon dioxide, and propylene glycol. The fluid-applied coating can include mica in the range of about 1% to about 5% by weight, silicon dioxide in the range of about 40% to about 70% by weight, and/or propylene glycol in the range of about 1% to about 5% by weight.

The fluid-applied coatings described herein can be cured after application under ambient conditions. Curing or drying can extend about 15 days. In another aspect, the curing or drying can extend more than 15 days.

The mesh of the systems and methods of the present disclosure can have an angle of orientation of weft to warp of about 90°. In another aspect, the mesh can exhibit an angle of orientation of weft to warp of about 45°. In still a further aspect, the mesh can exhibit an angle of orientation of weft to warp of less than 90°. In yet another aspect, the mesh can exhibit an angle of orientation of weft to warp of greater than 90°. In another aspect, the mesh of the system and method of the present disclosure can exhibit an area density in the range of at least about 200 g/m² to about 750 g/m². In still a further aspect, the mesh can exhibit an area density in the range of about 250 g/m² to about 600 g/m². In another aspect, the mesh can exhibit an area density in the range of about 350 g/m² to about 750 g/m². In another aspect, the mesh can exhibit an area density in the range of about 350 g/m² to about 550 g/m². In yet another aspect, the mesh can exhibit an area density of about 373 g/m². The mesh can be either woven or non-woven. The mesh also can be formed of a glass fiber material, a carbon fiber material, and/or a polyester fiber material, or other suitable material. The mesh can be a woven coated glass fiber reinforcing mesh, such as Sto Mesh 6 oz., which exhibits an area density of about 6 ounces/yard² (about 203 g/m²), Sto Intermediate Mesh, which exhibits an area density of about 11 ounces/yard² (about 373 g/m²), Sto Amor Mat, which exhibits an area density of about 15 ounces/yard² (about 509 g/m²), Sto Armor Mat XX, which exhibits an area density of about 20 ounces/yard² (about 678 g/m²), all of which are available from Sto Corp. Alternatively, the mesh can be a non-woven polyester fabric mesh, such as StoGuard® Fabric, or a non-woven thermoplastic elastomer fabric composite, such as StoGuard® Transition Membrane, also available from Sto Corp.

In a further aspect, the woven mesh of the systems and methods of the present disclosure can be oriented on the wall assembly with one of the weft or warp strands being parallel to the length of the joint and the other of the weft or warp being perpendicular to the joint over which the mesh is installed. In another aspect, the mesh can be oriented with one of the weft or warp strands being aligned at an angle of about 90° relative to the length of the joint over which the mesh is installed. In yet another aspect, the mesh can be oriented with one of the weft or warp strands being aligned at an angle of about 45° relative to the length of the joint over which the mesh is installed. In still a further aspect, the mesh can be oriented with one of the weft or warp strands being aligned at an angle of less than 90° relative to the length of the joint over which the mesh is installed. In another aspect, the mesh can be oriented with one of the weft or warp strands being aligned at an angle of greater than 90° relative to the length of the joint over which the mesh is installed.

The systems and methods of the present disclosure can be used with wall assemblies in which the covers of the walls form joints that have widths in the range of about 5 mm to about 20 mm. For joints in this range, the fluid-applied coating can be injected into the joint to fill all or a portion of the joint. Injection of the fluid-applied coating can be accomplished by applying the fluid-applied coating to the wall assembly using a trowel, or similar tool, under pressure. The thickness of each coating layer can be at least 2.5 mm. Alternatively, the thickness of one of the two coating layers can be less than about 1.6 mm and the other of the coating layers can have a thickness of about 2.5 mm. Alternative thicknesses of the coating layers are contemplated by the present disclosure.

In another aspect, where the systems and methods of the present disclosure are used in conjunction with a wall assembly that includes one or more joints formed by adjoining wall covers, a strip of suitable material, such as oriented strand board or plywood, can be inserted into the joint to at least partially fill the joint and bridge the gap between the adjoining wall covers. The insertion of the strip can be executed prior to the application of the first fluid-applied coating.

In another aspect, the systems and methods of structural reinforcement encompassed by the present disclosure can include reinforcement layers comprising a fluid-applied coating, wherein the coating comprises a weather resistive barrier, also known as an air and moisture barrier.

In one embodiment, the system of structural reinforcement encompassed by the present disclosure comprises the application of a first fluid-applied coating to a surface of a wall, wherein the first fluid-applied coating comprises an elastomeric acrylic polymer, such as StoGuard Shear. The first fluid-applied coating is applied over a joint formed in the surface of the wall and portions of the adjoining components of the wall forming the joint. A woven coated fiber glass mesh is applied to the first fluid-applied coating, wherein the mesh comprises warp strands and weft strands, and wherein the mesh exhibits an area density of approximately 373 g/m², such as Sto Intermediate Mesh. A second fluid-applied coating, such as StoGuard Shear, is applied to the first fluid-applied coating and mesh to form a reinforcement layer. The reinforcement layer can extend along at least a majority of the height of the surface of the wall to which the reinforcement layer is applied.

### Examples

Aspects of the present disclosure are illustrated in further detail in the following examples. The examples are provided to illustrate various aspects of the present disclosure and are not to be construed to limit the present disclosure.

Details of three samples of a bare wood frame shear walls that were tested are described. The samples were tested by subjecting them to lateral forces that were intended to mimic those forces that a building might encounter during high winds or earthquakes. Each bare wood frame shear wall had an area of 2438 mm by 3000 mm and included six 2 inch by 4 inch (51 mm by 102 mm) wood studs. The top plate and side studs of each sample were double studs, while the internal studs and bottom plate were single studs. Each wall sample included an 11 mm oriented strand board Type 1, EXP 1 complying with the Canadian Standards Association 0452 standard. The boards of oriented strand board used included two 1219 mm by 2438 mm boards and one 600 mm by 2438 mm board. The gap between these boards was approximately 3 mm. The frame of each sample was assembled using four nails 57 mm in length and 2.87 mm in diameter as toe nails and two nails 89 mm in length and 4.11 mm in diameter as end nails to join the studs to the seal plate. Each double stud of each frame included face nails 89 mm in length and 4.11 mm in diameter spaced approximately 610 mm on center apart along the length of the double stud. Each double top plate of each frame included face nails 89 mm in length and 4.11 mm in diameter spaced approximately 406 mm on center apart along the length of the double top plate. The top corners of each sample were reinforced with two rows of eight screws 76 mm in length and 3.76 mm in diameter. Each cover of each sample included nails 57 mm in length and 2.87 mm in diameter spaced approximately 152 mm on center apart along the edge of the cover and the same type nails spaced approximately 304 mm on center apart intermediately along the cover.

To two of the three samples, a first fluid-applied coating of StoGuard Shear was applied along the length of the gaps formed in the boards. The first fluid-applied coating was approximately 305 mm in width and applied over and parallel to the gaps. A strip of mesh, approximately 305 mm in width, was applied over each of the first fluid-applied coating strips along the length of the gaps in the boards. Over the mesh was applied a second coating of StoGuard Shear of approximately equal width. Each of the two coatings and mesh extending the length of the gaps. The StoGuard Shear coatings were allowed to dry over approximately 15 days after application.

The uncoated baseline sample of a bare wall and one of the samples to which was applied a reinforcement layers as encompassed by the present disclosure each were subjected to a first test protocol A that included a total displacement of 2769 mm and a maximum drift of 6.78%. The second test sample coated with a reinforcement layer was subjected to a second test protocol B that included a total displacement of 4115 mm and a maximum drift of 6.78%. The first test protocol A and the second test protocol B were the same as those set forth in Seismic Retrofit Guidelines, First Edition published by the UBC Earthquake Engineering Research Facility located in Vancouver, British Columbia, Canada.

Details of three samples of shiplap walls that were tested are also set forth herein. The shiplap walls were the same as the bare walls except that the shiplap wall covers were 1×6 inch, 2438 mm long, SPFN2 horizontal board fixed to studs with a 3 mm gap with the board being 19×140. The first shiplap sample set forth in Table 1 was unreinforced and subjected to cyclic protocol A. The second and third shiplap wall samples set forth in Table 1 were reinforced and subject to cyclic protocol A and B, respectively. Each reinforced shiplap wall was reinforced with a reinforcement layer comprising a first fluid-applied coating of StoGuard Shear applied to the entire surface of the shiplap wall sample. A layer of mesh was adhered to the first fluid-applied coating and covering the entire wall. The layer of mesh included Sto Intermediate Mesh with an area density of about 373 g/m² applied in approximately 38-inch (965 mm) strips. A second fluid-applied coating of StoGuard Shear was applied over the layer of mesh.

TABLE 1

| | | | | Maximum | Minimum | | Initial |
|---|---|---|---|---|---|---|---|
| | | | Cyclic | Force | Force | Work | Slope |
| Sample | Description | Reinforced | Protocol | kN | kN | kN*m | kN/% |
| 1 | Bare Wood Wall | No | A | 12.75 | −10.53 | 7.69 | 3580.90 |
| 2 | Bare Wood Wall | Yes | A | 23.42 | −22.52 | 11.14 | 6249.27 |
| 3 | Bare Wood Wall | Yes | B | 26.05 | −23.53 | 15.46 | 6539.03 |
| 4 | Shiplap Wood Wall | No | A | 6.16 | −5.83 | 5.00 | 2552.22 |
| 5 | Shiplap Wood Wall | Yes | A | 17.03 | −15.69 | 10.53 | 2729.46 |
| 6 | Shiplap Wood Wall | Yes | B | 18.21 | −15.24 | 11.69 | 2802.44 |

As shown in Table 1, the reinforced bare wall of sample 2 subjected to cyclic protocol A exhibited a resistance to a maximum force about 84% greater and a minimum force about 113% greater than the unreinforced bare wall of sample 1 and demonstrated work that was about 45% greater than the unreinforced bare wall. It also exhibited a stiffness that was about 74% greater than the unreinforced bare wall. The reinforced bare wall of sample 3 subjected to cyclic protocol B exhibited resistance to a maximum force about 104% greater and a minimum force about 124% greater than the unreinforced bare wall of sample 1 and demonstrated work that was about 40% greater than the unreinforced bare wall. It also exhibited a stiffness that was about 83% greater than the unreinforced bare wall.

As shown in Table 1, the reinforced shiplap wall of sample 5 exhibited resistance to a maximum force about 181% greater and a minimum force about 169% greater than the unreinforced shiplap wall. The reinforced shiplap wall of sample 5 exhibited work about 171% greater and stiffness about 9% greater than that exhibited by the unreinforced shiplap wall. The reinforced shiplap wall of sample 6 exhibited resistance to a maximum force 104% greater and a minimum force about 124% greater than exhibited by the unreinforced shiplap wall. The wall of sample 6 also exhibited work about 40% greater and stiffness about 83% greater than that exhibited by the unreinforced shiplap wall.

Out-of-plane testing also was performed on three different block masonry walls about 4 inch (about 102 mm) thick and reinforced with systems and methods encompassed by the present disclosure. The wall specimens used were 2.8 m high and 1.6 m wide and comprised 4-inch hollow concrete blocks. The first masonry wall had a first reinforcement layer comprising two reinforcement strips spaced apart from each other and extending vertically along the entire height of the wall and a second reinforcement layer on the opposing face of the wall also comprising two spaced apart reinforcement strips. Each reinforcement strip comprised a first fluid-applied coating of an elastomeric acrylic polymer coating of StoGuard Shear applied to the surface of the concrete block wall in a vertical strip approximately 12 inches (about 305 mm) in width and extending the height of the wall. Over the first fluid-applied coating was disposed a strip of woven glass fiberglass mesh, which exhibited an area density of about 15-16 ounces/yard (about 509-543 g/m²). Over the mesh was applied a second fluid-applied coating of the same elastomeric material.

The second masonry wall comprised a first reinforcement layer on one side of the wall and an identical second reinforcement layer disposed on the opposing surface of the wall. Each reinforcement layer comprised two vertical reinforcement strips spaced apart from each other and disposed on the major surfaces of the wall. Each reinforcement strip comprised a strip of a first fluid-applied coating of the same material as that found on the first masonry wall, with the strip being approximately 9.5 inches (about 241 mm) in width and extending the height of the wall. Over the first fluid-applied coating was applied a first mesh comprising a strip of the woven fiberglass mesh with a width approximately 9.5 inches (about 241 mm) and extending only from the top of the third course to the top of the eleventh course of blocks. A second mesh comprising strip of woven fiberglass mesh, which exhibited an area density of about 15-16 ounces/yard (about 509-543 g/m²), of equal width but longer than the first mesh, extending the length of the surface of the wall. A second fluid-applied coating of the same material as the first fluid-applied coating was applied over the underlying coating and mesh layers along the height of the wall.

The third wall had a reinforcement layer comprised of two reinforcement strips the same as those provided on the second wall, but only one face of the wall had a reinforcement layer provided thereon.

Each of the three walls were mounted on a shake table and subjected to lateral forces with a cyclic protocol similar to that of the 1995 Kobe, Japan Earthquake available from a suite of earthquakes from the SRG2 (as Van-133). Each wall was tested in sequence of increasing target intensity from 40%, 60%, 80%, 100%, 120% and 150%. The first wall also was subjected to 200% intensity, and the second wall was subjected to 180%, 200% and 225% intensity of the 1995 Kobe Earthquake.

The first wall failed at the mid-height at the 215% level. The second wall failed at the 225% level, and the third wall failed at the 56% level by collapse due to bending at the unreinforced face. In contrast, bare concrete block walls and concrete block walls reinforced with Unistrut were also tested. Two bare concrete block walls failed at 100% intensity and one bare wall failed at 60% intensity. One Unistrut wall failed at 120% intensity, and another Unistrut wall failed at 150% intensity. Therefore, the walls reinforced with the systems and methods encompassed by the present disclosure exhibited resistance to greater lateral forces in some arrangements.

The embodiments set forth herein are provided to illustrate the scope of the present disclosure, but are not provided to limit the scope thereof. The present disclosure contemplates alternative combinations and modifications of the features disclosed herein without departing from the scope thereof. Alternatives, variations, and modifications of the embodiments described herein will be apparent to one of ordinary skill in the art and are encompassed by the present disclosure.

1. A system for structural reinforcement comprising:
a reinforcement layer disposed on a surface of a substrate of a structure, wherein the surface comprises a base, a top aligned distal to the base, a height extending between the base and the top and an area disposed between the base and the top, and wherein the reinforcement layer extends along a majority of the height of the surface, and wherein the reinforcement layer comprises a first fluid-applied coating disposed on the surface, a mesh disposed on the first fluid-applied coating, wherein the mesh is adhered to the substrate by the first fluid-applied coating, and wherein the mesh exhibits an area density of at least about 200 g/m², and a second fluid-applied coating disposed on the mesh and at least a portion of the first fluid-applied coating.

2. The system of claim 1, wherein the reinforcement layer further comprising a second mesh disposed on the second fluid-applied coating.

3. The system of claim 2, wherein the reinforcement layer further comprises a third fluid-applied coating disposed on the second mesh and at least a portion of the second fluid-applied coating.

4. The system of claim 3, wherein at least one of the first fluid-applied coating, the second fluid-applied coating and the third fluid-applied coating comprise an elastomeric polymer.

5. The system of claim 4, wherein the elastomeric polymer comprises an acrylic polymer.

6. The system of claim 2, wherein at least one of the mesh and the second mesh comprises a woven glass fiber.

7. The system of claim 6, wherein the mesh comprises a first woven glass fiber comprising a first plurality of warp strands and a first plurality of weft strands, and wherein the second mesh comprises a second woven glass fiber comprising a second plurality of warp strands and a second plurality of weft strands, and wherein the first plurality of warp strands are aligned biased to the second plurality of warp strands within the reinforcement layer.

8. The system of claim 1, wherein the substrate comprises a joint, wherein the joint has a joint length and a joint width and wherein the first fluid-applied coating covers at least a portion of the joint.

9. The system of claim 8, wherein the first fluid-applied coating is disposed in at least a portion of the joint.

10. The system of claim 8, wherein the mesh comprises a woven fiber and a plurality of warp strands and a plurality of weft strands, and wherein at least one of the plurality of warp strands and the plurality of weft strands are oriented perpendicular to the length of the joint.

11. The system of claim 8, wherein the mesh comprises a woven fiber and a plurality of warp strands and a plurality of weft strands, and wherein at least one of the plurality of warp strands and the plurality of weft strands are oriented at an acute angle to the length of the joint.

12. The system of claim 1, wherein the mesh comprises a woven fiber.

13. The system of claim 12, wherein the mesh exhibits an area density in the range of about 200 g/m² to about 750 g/m².

14. The system of claim 12, wherein the mesh exhibits an area density in the range of about 250 g/m² to about 600 g/m².

15. The system of claim 12, wherein the mesh exhibits an area density in the range of about 350 g/m² to about 550 g/m².

16. The system of claim 12, wherein the mesh exhibits an area about 373 g/m².

17. The system of claim 12, wherein the mesh has a warp and a weft, and wherein the warp and the weft form an angle of about 90°.

18. The system of claim 12, wherein the mesh has a warp and a weft, and wherein the warp and the weft form an angle greater than 90°.

19. The system of claim 12, wherein the mesh has a warp and a weft, and wherein the warp and the weft form an angle of about 45°.

20. The system of claim 1, wherein at least one of the first fluid-applied coating and the second fluid-applied coating comprises an elastomeric polymer.

21. The system of claim 20, wherein the elastomeric polymer comprises an acrylic polymer.

22. The system of claim 1, wherein at least one of the first fluid-applied coating and the second fluid-applied coating comprises a latex-modified Portland cement material.

23. The system of claim 1, wherein at least one of the first fluid-applied coating and the second fluid-applied coating comprises a silyl-terminated polyether polymer.

24. The system of claim 1, wherein the substrate comprises a wood cover.

25. The system of claim 1, wherein the substrate comprises a masonry material.

26. The system of claim 1, wherein the reinforcement layer comprises a plurality of reinforcement strips extending between the top and the base of the surface, and wherein the plurality of reinforcement strips comprise the first fluid-applied coating, the mesh and the second fluid-applied coating.

27. The system of claim 26, wherein at least two of the plurality of reinforcement strips overlap.

28. The system of claim 1, wherein the reinforcement layer covers the surface of the substrate.

29. A method of reinforcing a structure against shear forces comprising the steps of:
applying a first fluid-applied coating to a surface of a substrate of a structure;
applying a mesh to the first fluid-applied coating, wherein the first fluid-applied coating adheres the mesh to the surface of the substrate, and wherein the mesh exhibits an area density of at least about 200 g/m²;
applying a second fluid-applied coating to the mesh and the first fluid-applied coating; and,
curing the first fluid-applied coating and the second fluid-applied coating to form a reinforcement layer.

30. The method of claim 29, wherein the curing has a time period of at least 15 days.

31. The method of claim 29, wherein the surface has a height, and wherein the reinforcement layer extends along a majority of the height of the surface.

32. The method of claim 29, further comprising applying a second mesh to the second fluid-applied coating.

33. The method of claim 32, further comprising applying a third fluid-applied coating to the second mesh.

34. The method of claim 29, wherein at least one of the first fluid-applied coating and the second fluid-applied coating comprises an elastomeric polymer.

35. The method of claim 29, wherein the reinforcement layer comprises a plurality of strips.

36. The method of claim 29, wherein applying the mesh further comprises orienting a warp at an angle perpendicular to a joint formed in the substrate.
